(19) United States
(12) Patent Application Publication
(10) Pub. No.: US 2026/0054429 A1
(43) Pub. Date: Feb. 26, 2026

(54) METHOD AND MATERIALS FOR MANUFACTURING HIGH-EFFICIENCY HEATING ENCLOSURES AND APPLIANCES

(71) Applicant: UT-Battelle, LLC, Oak Ridge, TN (US)

(72) Inventors: Steve E. Bullock, Knoxville, TN (US); Ahmed G. Abuheiba, Henderson, NV (US); Ahmed A. Hassen, Knoxville, TN (US); Seokpum Kim, Knoxville, TN (US); Vipin Kumar, Knoxville, TN (US); Vlastimil Kunc, Knoxville, TN (US); Steven J. Guzorek, Knoxville, TN (US)

(21) Appl. No.: 19/307,584

(22) Filed: Aug. 22, 2025

Related U.S. Application Data
(60) Provisional application No. 63/685,991, filed on Aug. 22, 2024.

(51) Int. Cl. B29C 43/00; B29C 43/52; B29K 83/00; B29K 105/26; B29K 309/08; B29L 31/00; B32B 3/30; B32B 27/08; B32B 27/28

(52) U.S. Cl. CPC B29C 43/003; B29C 43/52; B32B 3/30; B32B 27/08; B32B 27/283; B29K 2083/00; B29K 2105/26; B29K 2309/08; B29L 2031/762; B32B 2250/03; B32B 2250/40; B32B 2255/10; B32B 2255/20; B32B 2260/046; B32B 2262/101; B32B 2305/70; B32B 2509/00

(57) ABSTRACT

A method of making an oven cavity of a cooking appliance, and a cooking appliance made therewith, are provided. The method includes forming a composite sheet via sheet molding compound. The composite sheet includes glass fiber impregnated with silicone polymer. An intermediate assembly is formed by disposing a layer comprising an insulative material onto a first layer of the composite sheet. The intermediate assembly is inserted into a mold. A compression load is applied to the intermediate assembly in the mold to obtain a molded piece. One or more of the molded piece forms a composite body that defines the oven cavity of the cooking appliance. The silicone polymer may include one or more of poly dimethylsiloxane, poly methylphenyl silanol, poly diphenyl silanol, and poly vinyl functional backbone silicones having methyl hydrosilane crosslinkers. The insulative material may include ceramic foam, hollow glass microspeheres, or recycled glass powder.

### CROSS-REFERENCE TO RELATED APPLICATIONS

This application claims the benefit of U.S. Provisional Application No. 63/685,991, filed Aug. 22, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to materials for and a method of manufacturing high-efficiency heating enclosures such as for cooking appliances.

### BACKGROUND OF THE INVENTION

Current kitchen appliances, such as household and commercial cooking ovens, are constructed using metals including steel due to their low cost and ease of stamping. As shown by way of example in FIGS. 1 and 2, a typical cooking oven 10 has a cavity 11 that is formed by stamping steel into pieces 12a, 12b, 12c, 12d, 12e that are assembled into an enclosure or chassis 13 and welded or otherwise bonded together. The steel chassis 13 is then surrounded on its exterior by insulation 14. The steel chassis 13 and surrounding insulation 14 are subsequently inserted into a metal outer enclosure underneath a cooking range that forms the top of the outer enclosure to assemble a conventional cooking oven.

Alternative materials to metals such as polymers are generally not capable of continuous cycling at the high temperatures (260° C./500° F.) that are encountered in appliance use. Further, specialty polymers like polyether ether ketone (PEEK) and poly aryl amide (PARA) are high in cost (e.g., approximately $1/gram), have the potential to off-gas organic compounds at high temperatures around 500° F. resulting in resin odor and/or possible food contamination, and are not generally approved for food use by the FDA. These polymers are used as a replacement for metal parts in surgical applications and the automotive sector, but are generally not suitable of use in cooking appliances.

Further, conventional electric cooking ovens are currently only about 10 to 12% energy efficient and consume around 100 TBtu of energy annually nationwide in the U.S. Most of the energy consumed does not even go into cooking food and is instead largely lost to the exterior either radiantly or convectively. Retaining the heat in the cooking air mass and cavity walls of the chassis for extended periods of time is challenging with conventional designs. For example, oven cavity interior surfaces are often coated with enamel that has high temperature resistance and high emissivity which is beneficial for good radiative heat transfer from the walls of the cavity to the load. However, the enamel also increases heat transfer from the outer walls of the cavity to the surrounding insulation. Furthermore, the surrounding insulation is constrained by the available space between the cavity enclosure and the outer walls of the oven cabinet as well as by the maximum operating temperature of the outer wall of the cavity enclosure. Energy is therefore supplied to the oven heating elements in the form of a square wave (heater ON/OFF) at a high power level to ensure providing enough energy to overcome the heat transfer to the load and the heat loss to the ambient surroundings.

Therefore, a continued need exists for alternative materials and methods of constructing cooking appliances that can provide for one or more of replacing the use of steel, having improved thermal efficiency, reducing energy consumption, and having a lower environmental impact.

### SUMMARY OF THE INVENTION

A method of making an oven cavity of a cooking appliance is provided. The method includes the step of forming a composite sheet manufactured via sheet molding compound. The composite sheet includes glass fiber impregnated with silicone polymer. The method further includes the step of forming an intermediate assembly, the step including disposing a layer comprising an insulative material onto a first layer of the composite sheet. The method further includes the step of inserting the intermediate assembly into a mold. The method further includes the step of applying a compression load to the intermediate assembly in the mold to obtain a molded piece. One or more of the molded piece forms a composite body that defines the oven cavity of the cooking appliance.

In specific embodiments, the insulative material is selected from a group consisting of: i) a ceramic foam insulation this is one of an alumina or alumina-silicate foam; ii) hollow glass microspheres; and iii) recycled glass powder obtained from processing fiberglass.

In specific embodiments, the silicone polymer includes one or more of: i) poly dimethylsiloxane; ii) poly methylphenyl silanol; iii) poly diphenyl silanol; iv) poly vinyl functional backbone silicones; and v) poly vinyl functional backbone silicones including methyl hydrosilane (Me-Si-H) crosslinkers.

In specific embodiments, the glass fiber includes recycled glass fiber (RGF).

In specific embodiments, the step of forming an intermediate assembly further includes disposing a second layer of the composite sheet onto the layer comprising insulative material. The layer comprising insulative material is sandwiched between the first layer of the composite sheet and the second layer of the composite sheet.

In specific embodiments, the method further includes the step of applying a layer comprising a polycarbosilane onto a surface of the first layer of the composite sheet.

In some embodiments, the step of forming the composite sheet further includes partially curing the composite sheet prior to disposing the insulative material onto the first layer of the composite sheet. In other embodiments, the step of forming the composite sheet further includes fully curing the composite sheet prior to disposing the insulative material onto the first layer of the composite sheet.

In specific embodiments, the step of applying a compression load to the intermediate assembly further includes applying heat to the intermediate assembly.

In some embodiments, the composite body is integrally formed by one and only one single molded piece. In other embodiments, the composite body is formed by a plurality of the molded pieces, and the method further includes assembling the plurality of the molded pieces to build the composite body.

A cooking appliance is also provided. The cooking appliance includes a composite body defining an oven cavity of the cooking appliance. The composite body includes one or more molded pieces. Each molded piece includes at least a first layer and a second layer. The first layer includes glass fiber impregnated with silicone polymer and is manufactured via sheet molding compound. The second layer includes an insulative material. The second layer is disposed on the first layer.

In specific embodiments, the insulative material is selected from a group consisting of: i) a ceramic foam insulation this is one of an alumina or alumina-silicate foam; ii) hollow glass microspheres; and iii) recycled glass powder obtained from processing fiberglass.

In specific embodiments, the silicone polymer includes one or more of: i) poly dimethylsiloxane; ii) poly methylphenyl silanol; iii) poly diphenyl silanol; and iv) poly methylvinvl, vinyl, or hydrogen endcapped silicones cured with peroxide and/or a platinum hydrosilation catalyst.

In specific embodiments, the glass fiber includes recycled glass fiber (RGF).

In specific embodiments, each molded piece further includes a third layer including glass fiber impregnated with silicone polymer and that is manufactured via sheet molding compound. The second layer is sandwiched between the first layer and the third layer.

In specific embodiments, the third layer has the same composition as the first layer.

In specific embodiments, the second layer includes a plurality of dimples.

In specific embodiments, each molded piece further includes a fourth layer coated on a surface of the first layer that is opposite the second layer. The fourth layer includes a silicon carbide.

In specific embodiments, the cooking appliance is one of an electric oven and a microwave oven.

These and other features of the invention will be more fully understood and appreciated by reference to the description of the embodiments and the drawings.

### BRIEF DESCRIPTION OF THE DRAWINGS

FIG. 1 is an exploded view of a metal chassis and surrounding insulation of a cooking oven in accordance with the prior art;

FIG. 2 is a schematic view illustrating the assembly of a conventional metal chassis of a cooking oven in accordance with the prior art;

FIG. 3 is a schematic flow diagram of a process of making a molded piece that forms a composite body that defines an oven cavity of a cooking appliance in accordance with embodiments of the disclosure;

FIG. 4 is a sectional view of the molded piece in accordance with embodiments of the disclosure;

FIG. 5 is a perspective view of a molded piece in accordance with other embodiments of the disclosure;

FIG. 6 is a sectional view of the molded piece of FIG. 5; and

FIG. 7 is a perspective view of a composite body defining an oven cavity of a cooking appliance formed with molded pieces according to the embodiment of FIG. 5.

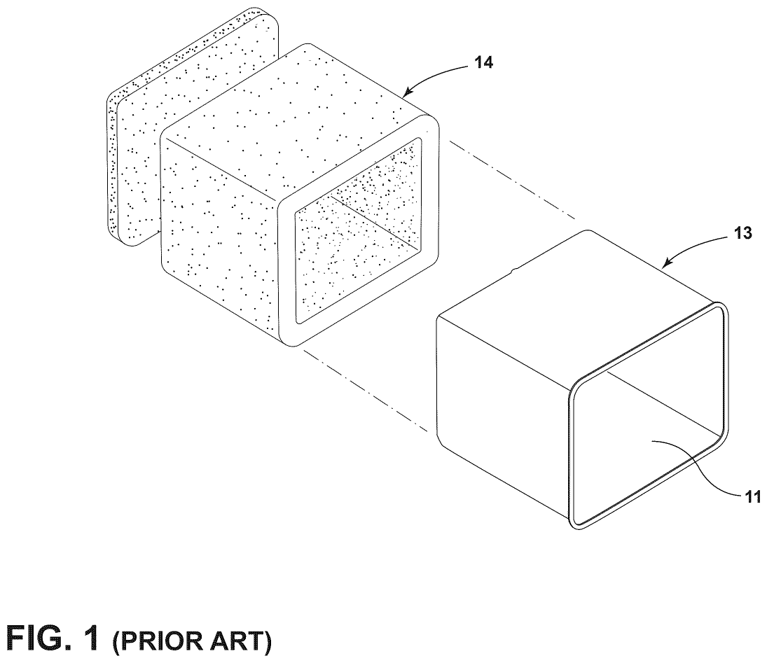

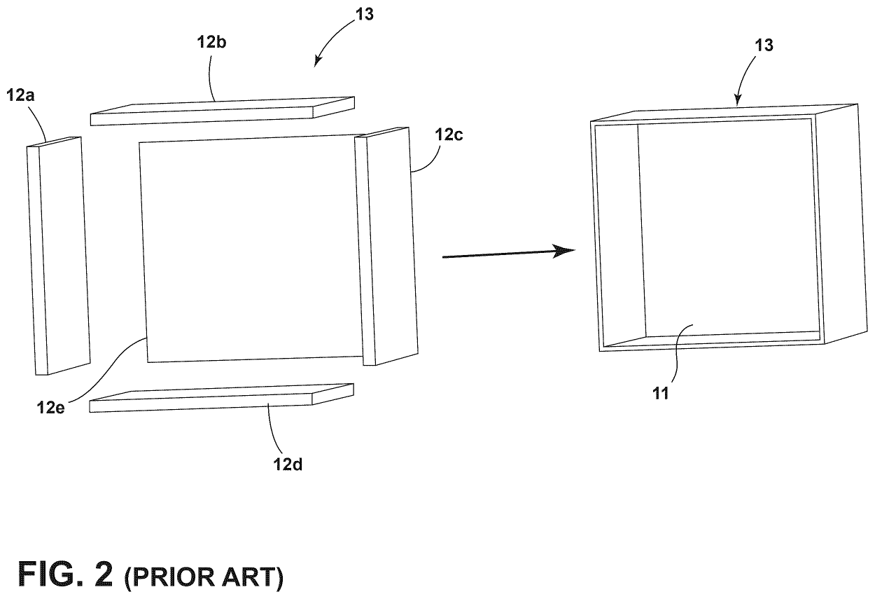

### DETAILED DESCRIPTION OF THE CURRENT EMBODIMENTS

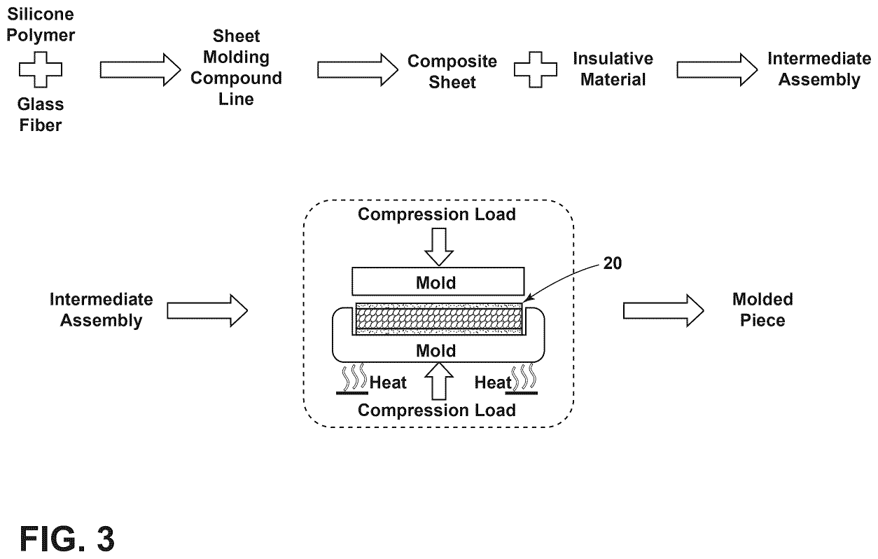

As discussed herein, the current embodiments relate to a method of making an oven cavity of a cooking appliance and a cooking appliance made by the method. As generally illustrated in FIG. 3, the method includes forming a composite sheet including glass fiber impregnated with silicone polymer, and molding a layer of the composite sheet with a layer including an insulative material to form a composite body that defines the oven cavity of the cooking appliance. The steps of the method are separately described in more detail below.

The method first includes forming a composite sheet. The composite sheet includes glass fiber impregnated with silicone polymer material. In various embodiments, the composite sheet is formed by a sheet molding compound process in which the silicone polymer material is deposited onto a plastic carrier film on a conveyor feed belt or directly onto the conveyor feed belt without the carrier film, and while conveying the silicone polymer material the glass fiber is added on top of the silicone polymer material which allows the glass fiber to drift through the silicone polymer material, and heat and/or pressure is applied to the silicone-impregnated glass fiber. In certain embodiments, the thus obtained silicone-impregnated glass fiber is only partially cured/B-staged by application of heat and/or pressure to provide for good adhesion in the subsequent molding step. However, in other embodiments, the composite sheet is fully cured. The composite sheet includes less than 50 vol. % of the glass fiber, optionally between 10 and 50 vol. %, optionally between 20 and 50 vol. %, optionally between 30 and 50 vol. %, optionally between 35 and 45 vol. %. The composite sheet may also optionally include filler material, such that the balance of the composite sheet includes silicone polymer material and optional filler, i.e., the glass fiber, silicone polymer material, and optional filler sum to 100 vol. %.

The silicone polymer material includes one or more of poly dimethylsiloxane, poly methylphenyl silanol, poly diphenyl silanol, and poly vinyl functional backbone silicones including methyl hydrosilane (Me-Si-H) crosslinkers. Silicone polymers such as poly dimethyl siloxanes (PDMS) are routinely used for contact with food. For example, silicone baking sheets are commercially available and can be used to cook at 450° F. without fear of food contamination and chemical degradation. These silicone polymers are approved for food use by the FDA and have also been accepted by the general public as safe.

The glass fiber impregnated with the silicone polymer material optionally may be recycled glass fiber, but may also include virgin glass fiber. The recycled glass fiber may be obtained from one or more various sources such as, but not limited to, wind turbine blades, the boating industry, transportation vehicles, and sporting goods. The glass fiber may be cut and randomly chopped before adding to the silicone polymer material. Alternatively, the glass fiber may be aligned rather than randomly chopped, or may be formed into glass microspheres. The glass fiber is loaded into the silicone polymer at a sufficient volume to provide mechanical stiffness and heat resistance.

The method next includes forming an intermediate assembly including the step of disposing a layer including an insulative material onto a first layer formed of the composite sheet material. Optionally, in preferred embodiments, a second layer formed of the composite sheet material is disposed on the layer of insulative material opposite the first layer in order to sandwich the layer of insulative material between the two separate face layers of composite sheet material. The two separate layers of composite sheet material may have the same composition, or alternatively may have different composition such as by including different silicone polymer materials. In some embodiments, the insulative material is a ceramic foam insulation such as an alumina or alumina-silicate foam. In other embodiments, the insulative material is formed of hollow glass microspheres. In yet other embodiments, the insulative material is formed of recycled glass powder obtained from processing fiberglass. In yet other embodiments, the insulative material may include any combination of these materials. The insulative material should have porosity to allow for a flow of air through the insulative material.

Subsequently, the intermediate assembly is inserted into a mold. Once the intermediate assembly is placed in the mold, the method next includes applying a compression load to the intermediate assembly to obtain a molded piece. One or more of the molded piece thus obtained forms a composite body that defines the oven cavity of the cooking appliance. In some embodiments, the composite body is integrally formed by one and only one single molded piece. In other embodiments, the composite body is formed by obtaining a plurality of molded pieces according to the steps described above, and assembling the plurality of molded pieces to build the composite body with the molded pieces. The molded pieces may be joined by adhering, bonding, taping, or similar.

Optionally, a layer of a polycarbosilane material may be coated on an outer surface of one of the composite sheet layers. Polycarbosilane is a polymeric precursor for amorphous silicon carbide (SiC) that is an oxidation resistant ceramic that is stable to temperatures of up to 900° C. in air. In some embodiments, the polycarbosilane may be coated onto the composite sheet layer after the molding step. In other embodiments, the polycarbosilane may be compression molded with the intermediate assembly of composite sheet(s) and insulative material to form an amorphous silicon carbide layer. For example, polycarbosilane is compatible with phenyl-methyl silicones and forms silicon oxycarbide with good adhesion when co-molded and pyrolyzed, resulting in a black top coating. Because the polycarbosilane polymer chemistry has similarities to the siloxane polymers, these two polymers may be combined for specific high temperature durability in cooking ovens. However, high-temperature coatings other than polycarbosilane may be used as an alternative.

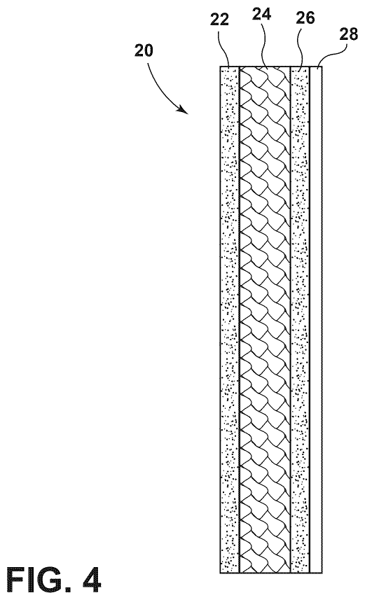

With reference to FIG. 4, in some embodiments a molded piece 20 formed by the method includes a first layer 22 formed of a composite sheet as described above, a second layer 24 formed of the insulative material, and a third layer 26 formed of another composite sheet as described above. The second layer 24 is sandwiched between the two layers 22, 26 of composite sheet material. Optionally, the molded piece 20 includes a fourth layer 28 coated on the outer surface of the third layer 26 that faces away from the first and second layers 22, 24. The optional fourth layer 28 is formed by applying a polycarbosilane to the surface of the third layer 26 to form a silicon carbide layer.

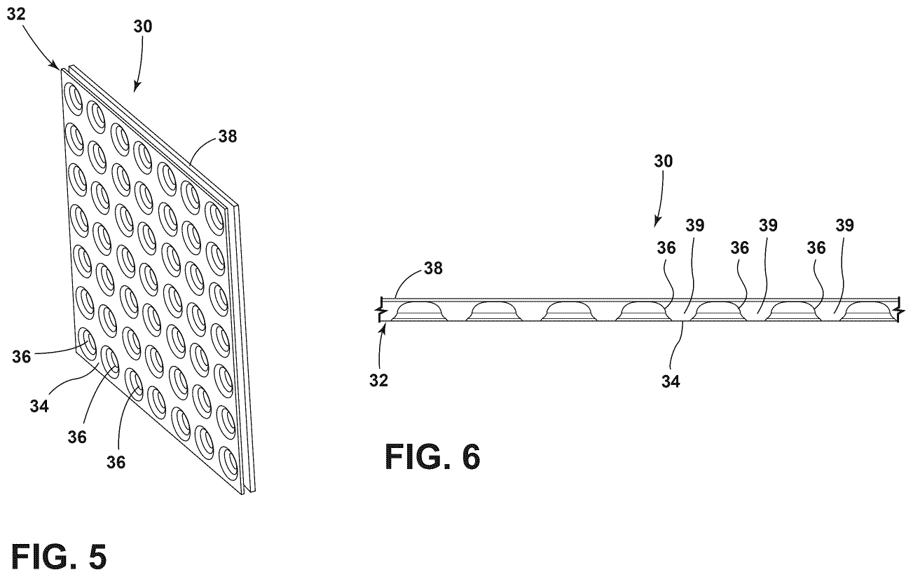

Turning to FIGS. 5 and 6, in some embodiments the molded piece 30 formed by the method has a layer of insulative material 32 that includes a sheet 34 a plurality of dimples 36 or other similar depressions on one side surface that form a plurality of coinciding bumps or other raised projections on the opposite side surface. The dimples 36 are shown as having a circular cross-section and spherical-like curved shape, but it should be understood that the dimples may have any other shape that is a depression on one side and raised on the opposite side of the sheet. The dimples 36 are arranged in a regular pattern and are disposed over the entirety of the sheet 34, but it should be understood that the dimples may be disposed in an irregular pattern on the sheet. A layer 38 of composite sheet material is disposed on the side of the insulative sheet 34 adjacent the raised projections of the dimples 36. Thus, a plurality of airways 39 are formed between the insulative sheet 34 and the composite sheet layer 38 thereby allowing for flow of air through the molded piece 30. The insulative sheet 34 and sheet layer 38 as such form a dimple core structure. Although not shown, is should be understood that a second composite sheet layer may be disposed adjacent the depression side surface of the insulative sheet 34 opposite the first composite sheet layer 38 such that the insulative sheet 34 is sandwiched between two composite sheet layers.

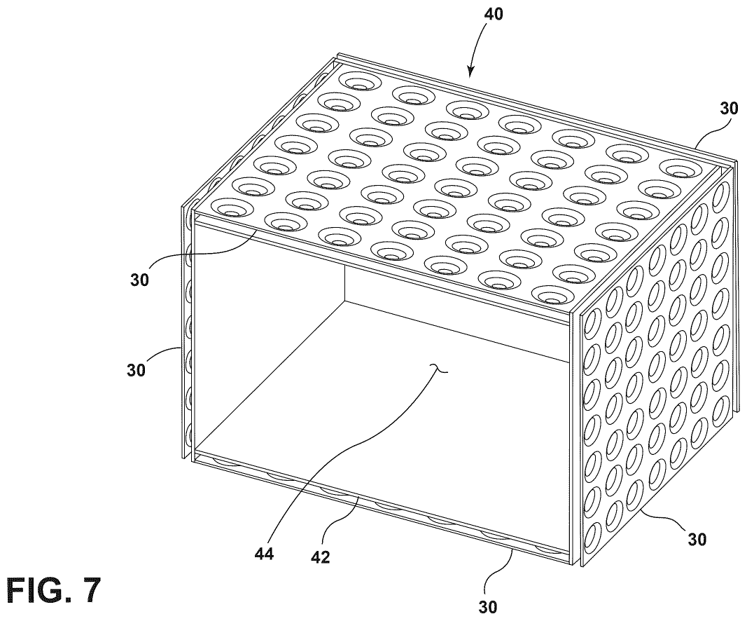

As shown in FIG. 7, a composite body 40 obtained by the method may be formed of a plurality of the molded pieces 30. The molded pieces 30 are joined together to form a box-like enclosure having an opening 42 into the cavity 44 defined by the walls of molded pieces 30. Due to molded pieces 30 each having an insulative layer, the composite body 40 is integrally insulated. In various embodiments, the composite body 40 defines an oven cavity of a cooking appliance such as an electric oven, a gas oven, or a microwave oven. The composite body 40 thus may be substituted for the metal chassis and surrounding insulation that is typically used to form the oven cavity of conventional cooking appliances. However, it should be understood that the composite body may be used for other applications. It should also be understood that the composite body may be formed by only one single molded piece rather than a plurality of molded pieces.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making an oven cavity of a cooking appliance, the method comprising the steps of:
forming a composite sheet manufactured via sheet molding compound, the composite sheet comprising glass fiber impregnated with silicone polymer;
forming an intermediate assembly including disposing a layer comprising an insulative material onto a first layer of the composite sheet;
inserting the intermediate assembly into a mold; and
applying a compression load to the intermediate assembly in the mold to obtain a molded piece;
wherein one or more of the molded piece forms a composite body that defines the oven cavity of the cooking appliance.

2. The method of claim 1, wherein the insulative material is selected from a group consisting of: i) a ceramic foam insulation this is one of an alumina or alumina-silicate foam; ii) hollow glass microspheres; and iii) recycled glass powder obtained from processing fiberglass.

3. The method of claim 1, wherein the silicone polymer comprises one or more of: i) poly dimethylsiloxane; ii) poly methylphenyl silanol; iii) poly diphenyl silanol; and iv) poly vinyl functional backbone silicones including methyl hydrosilane (Me-Si-H) crosslinkers.

4. The method of claim 1, wherein the glass fiber comprises recycled glass fiber (RGF).

5. The method of claim 1, wherein the step of forming an intermediate assembly further includes disposing a second layer of the composite sheet onto the layer comprising insulative material, wherein the layer comprising insulative material is sandwiched between the first layer of the composite sheet and the second layer of the composite sheet.

6. The method of claim 1, further comprising the step of applying a layer comprising a polycarbosilane onto a surface of the first layer of the composite sheet.

7. The method of claim 1, wherein the step of forming the composite sheet further comprises partially curing the composite sheet prior to disposing the insulative material onto the first layer of the composite sheet.

8. The method of claim 1, wherein the step of forming the composite sheet further comprises fully curing the composite sheet prior to disposing the insulative material onto the first layer of the composite sheet.

9. The method of claim 1, wherein the step of applying a compression load to the intermediate assembly further comprises applying heat to the intermediate assembly.

10. The method of claim 1, wherein the composite body is integrally formed by one and only one single said molded piece.

11. The method of claim 1, wherein the composite body is formed by a plurality of said molded pieces, and the method further comprises assembling the plurality of said molded pieces to build the composite body.

12. A cooking appliance comprising:
a composite body defining an oven cavity of the cooking appliance;
wherein the composite body includes one or more molded pieces, each molded piece including at least a first layer and a second layer, the first layer comprising glass fiber impregnated with silicone polymer and being manufactured via sheet molding compound, the second layer comprising an insulative material, and the second layer being disposed on the first layer.

13. The cooking appliance of claim 12, wherein the insulative material is selected from a group consisting of: i) a ceramic foam insulation this is one of an alumina or alumina-silicate foam; ii) hollow glass microspheres; and iii) recycled glass powder obtained from processing fiberglass.

14. The cooking appliance of claim 12, wherein the silicone polymer comprises one or more of: i) poly dimethylsiloxane; ii) poly methylphenyl silanol; iii) poly diphenyl silanol; and iv) poly methylvinvl, vinyl, or hydrogen endcapped silicones cured with peroxide and/or a platinum hydrosilation catalyst.

15. The cooking appliance of claim 12, wherein the glass fiber comprises recycled glass fiber (RGF).

16. The cooking appliance of claim 12, wherein each molded piece further includes a third layer comprising glass fiber impregnated with silicone polymer and being manufactured via sheet molding compound, and the second layer is sandwiched between the first layer and the third layer.

17. The cooking appliance of claim 16, wherein the third layer has the same composition as the first layer.

18. The cooking appliance of claim 12, wherein the second layer includes a plurality of dimples.

19. The cooking appliance of claim 12, wherein each molded piece further comprises a fourth layer coated on a surface of the first layer that is opposite the second layer, the fourth layer comprising a silicon carbide.

20. The cooking appliance of claim 12, wherein the cooking appliance is one of an electric oven and a microwave oven.

21. A cooking appliance comprising the oven cavity made by the method of claim 1.
